(19) United States
(12) Patent Application Publication
(10) Pub. No.: US 2011/0138299 A1
(43) Pub. Date: Jun. 9, 2011

(54) METHOD AND APPARATUS FOR SUGGESTING DATA FOR TRANSFER

(75) Inventors: Craig Pugsley, Paignton (GB); Jesmond Allen, Avon (GB); Jonathan Davies, Arnos Vale (GB); Maulik Sailor, Sweetman Place (GB)

(73) Assignee: Nokia Corporation, Espoo (FI)

(21) Appl. No.: 12/631,678

(22) Filed: Dec. 4, 2009

(51) Int. Cl. G06F 3/048

(52) U.S. Cl. 715/748; 715/825

(57) ABSTRACT

An approach is provided for suggesting data for transfer from an electronic data storage medium to another electronic data storage medium. An external device receives an input for specifying an amount of data to transfer from a first storage medium to a second storage medium. An external device also determines an available storage space in the second storage medium. Then, the external device generates, based on the input and the available storage space, a list of data to suggest for transfer from the first storage space to the second storage medium.

### BACKGROUND

As users become more reliant on electronic devices, electronic storage medium has become a popular method to store information such as documents, music, videos, books, etc. in a form of electronic data. The electronic storage medium is advantageous in that it is relatively inexpensive and can hold a large volume of information while occupying little space. Further, transfer of information is easy between electronic storage media. However, because electronic data is not tangible or visible, it is not always easy to locate or manage electronic data stored on such medium. Therefore, it may be time-consuming and tedious to browse a large volume of electronic data stored in one medium, and to select desired data to transfer to another medium. Therefore, an efficient way to transfer data between electronic storage media is desired to save time and effort of a user.

### SOME EXAMPLE EMBODIMENTS

Therefore, there is a need for an approach for suggesting data for transfer from one electronic data storage medium to another electronic data storage medium.

According to one embodiment, a method comprises receiving an input for specifying an amount of data to transfer from a first storage medium to a second storage medium. The method also comprises determining an available storage space in the second storage medium. The method further comprises generating, based on the input and the available storage space, a list of data to suggest for transfer from the first storage space to the second storage medium.

According to another embodiment, an apparatus comprising at least one processor, and at least one memory including computer program code, the at least one memory and the computer program code configured to, with the at least one processor, cause, at least in part, the apparatus to receive an input for specifying an amount of data to transfer from a first storage medium to a second storage medium. The apparatus is also caused to determine an available storage space in the second storage medium. The apparatus is further caused to generate, based on the input and the available storage space, a list of data to suggest for transfer from the first storage space to the second storage medium.

According to another embodiment, a computer-readable storage medium carrying one or more sequences of one or more instructions which, when executed by one or more processors, cause, at least in part, an apparatus to receive an input for specifying an amount of data to transfer from a first storage medium to a second storage medium. The apparatus is also caused to determine an available storage space in the second storage medium. The apparatus is further caused to generate, based on the input and the available storage space, a list of data to suggest for transfer from the first storage space to the second storage medium.

According to another embodiment, an apparatus comprises means for receiving an input for specifying an amount of data to transfer from a first storage medium to a second storage medium. The apparatus also comprises means for determining an available storage space in the second storage medium. The apparatus further comprises means for generating, based on the input and the available storage space, a list of data to suggest for transfer from the first storage space to the second storage medium.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of suggesting data for transfer, according to one embodiment;

FIG. 2 is a diagram of the components of the external device, according to one embodiment;

FIG. 3 is a flowchart of a process for suggesting data for transfer, according to one embodiment;

FIG. 4 is a flowchart of a process for suggesting data for transfer, according to one embodiment;

FIG. 5 is a flowchart of a process for suggesting data for transfer, according to one embodiment;

FIG. 6 is a diagram of user interfaces utilized in the processes of FIG. 3, according to one embodiment;

FIGS. 7A-7B are diagrams of user interfaces utilized in the processes of FIG. 3, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for suggesting data for transfer are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

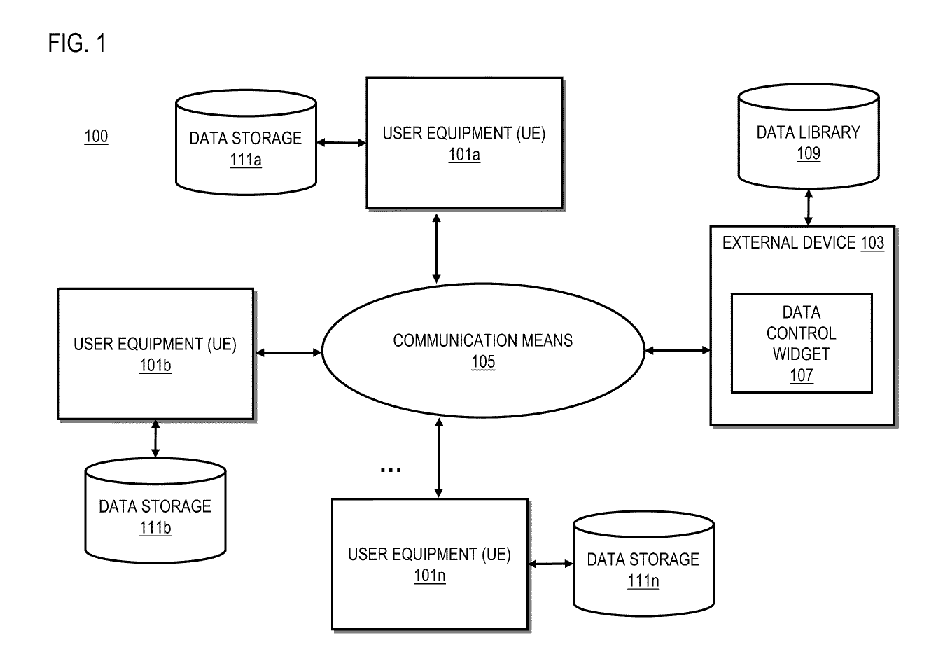

FIG. 1 is a diagram of a system capable of suggesting electronic data/file for transfer, according to one embodiment. The electronic data/file may be, for example music, audio, video, text, photographs, game applications, electronic book files, drawings, computer programs, electronic documents, service guide information, maps, point of interest information, and the like, or any combination thereof. As electronic devices such as computers and portable devices become more common, people rely on electronic devices significantly in their daily lives. These electronic devices are used in a wide range of activities, including playing music or movies, displaying documents or electronic books, drawing and editing pictures, etc. Further, the electronic devices often include or connect to an electronic storage medium to store electronic data of various forms such as music, movies, photos documents, etc. The electronic storage medium provides a convenient means to store a large amount of information because it can hold a large volume of information while taking considerably small space. Further, a large volume of electronic data may be transferred easily between two locations or two different storage media over a communication network or via link over a direct connect wire or cable. Users can also share their data, such as music, photos, personal information and etc., with others by posting their data on a server on a communication network. Furthermore, storing data in electronic form allows easy manipulation of data. For example, it is often easier to perform editing, copying and deleting of electronic data than non-electronic data. With the widespread use of the electronic devices, people are constantly surrounded by and dependent on electronic data storage. For example, people make daily use of computers that have hard drives as electronic data storage, and also use mobile phones or other portable devices such as a portable media player that have electronic data storage media.

While transferring a large volume of data may be easily performed using electronic data, it is often required for a user to manually select data to transfer from one storage medium to another storage medium. If the storage capacity of a transferee storage medium is equal to or greater than the storage of a transferor storage medium, then it is possible to transfer the entire data from the transferee storage medium to the transferor storage medium. However, in a case where the transferee storage medium has a smaller storage capacity than the transferor storage medium, not all data can be transferred. As an example, when data is transferred from a large data library within a hard drive of a personal computer to a portable media player, the portable media player generally has a smaller capacity than the hard drive. As a result, not all of the data from the personal computer can be transferred to the portable media player, which in turn makes it often necessary for a user to manually select data to transfer to the device.

As more users rely on electronic data to enjoy music, movies, photos, etc. in the form of digital media, they are building large collections of data. These large collections can make the process for manually selecting data for transfer time-consuming and tedious because the user often has to browse a large volume of data to determine which data to transfer. At the same time, as digital storage medium becomes more common and inexpensive, portable media players generally have a large capacity. Because modern portable media players can hold more data, a user may need to spend more time selecting data to transfer to the portable media player. Further, people's preferences in media constantly change, and they may become bored with playing the same media repeatedly. Therefore, people may constantly update their data library by adding or deleting data. This constant updating by the manual means described above can be quite time-consuming and laborious, which can in turn discourage users from making full use of their data libraries. Therefore, for at least these reasons, an efficient way is needed to add data or update the content of a device.

To address this problem, a system 100 of FIG. 1 introduces the following capabilities: (1) specifying an amount of data to transfer from a transferor storage medium (i.e. a first storage medium) to a transferee storage medium (i.e. a second storage medium) (2) determining an available storage space in the transferee storage medium (3) generating, based on the specified amount and the available storage space, data to suggest for transfer (4) transferring the data to the transferee storage medium based on the suggestion. More specifically, the system 100 analyzes, for instance, the available media collection and storage capacities to suggest data to transfer to a storage medium based on various parameters and/or user-specified preferences such that a user does not have to spend time browsing a large volume of data in order to select data to transfer. Accordingly, this approach saves time and effort by a user in selecting data to transfer to another storage medium. This approach also provides users an easy way to shuffle the content of the storage medium by suggesting a new set of data to transfer.

As shown in FIG. 1, the system 100 comprises a user equipment (UE) 101 having connectivity to an external device 103 via a communication means 105. By way of example, the communication means 105 of system 100 can be any form of means that allow communication between devices. For example, the communication means 105 may be an electrical wire or cable connecting the devices. As another example, the communication means 105 may be a communication network including one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN) network, Internet Protocol (IP) Datacast network, satellite, radio/television broadcast network, short range wireless network, Bluetooth® network, mobile ad-hoc network (MANET), and the like.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, game device, electronic book device, positioning device, or any combination thereof. It is also contemplated that the UE 101 can support any type of interface to the user (such as “wearable” circuitry, etc.). The UE 101 also includes or is connected to data storage medium 111 to store data and/or to access the stored data.

The external device 103 is a device connected to the UE 101 to exchange data via the communication means 105. The external device 103 includes or is connected to a data library 109 to store data and/or access the stored data, wherein the data library 109 is a form of storage medium to store electronic data. For example, data from the data library storage medium may be copied or transferred to the data storage medium 111 of the UE 101 via the communication means 105. Similarly, the data from the data storage medium 11a may also be copied and/or transferred to the data library 109. The external device 103 also includes a data control widget 107 to control various operations including data transfer between devices or storage media. Although not shown in FIG. 1, the UE 101 may also include a type of a widget to control data transfer via the communication means 105.

The UE 101 and the external device 103 may be any type of electronic device that can store electronic data. For example, the external device 103 may be a personal computer with a hard drive as the data library 109. Further, the user equipment 101 may be a portable media player with a memory to store digital media as the data storage medium 111. In another example, the external device may be a server on a network with a large storage medium as the data library 109, wherein the communication means 105 is a communication network, and the UE 101 may be any type of device including a personal computer, a portable device, etc. Further, the data storage medium 111 may store various types of information including information about the user of the UE 101. The information about the user may include user preferences, a user profile including the user's id, name, birthday etc., as well as a user's tendency or history of accessing data. The data library 109 may include information about the user(s) connected via the communication means 105.

In one embodiment, the user may use the data control widget 107 of the external device 103 to initiate transfer of data from the data library 109 to the UE 101. If there is a sufficient storage space in the data storage medium 111 to accommodate the data to be transferred, then the data is transferred to the data storage medium 111. However, if there is insufficient storage space in the data storage medium 111, then the data control widget 107 of the external device 103 shows a prompt indicating that there is insufficient storage space. In the prompt, a list of content in the data storage medium 111 is suggested for deletion from the data storage medium 111.

The data control widget 107 in the external device 103 may be a software application that provides visualization (e.g. graphical user interface) to allow a user accessing the external device 103 to perform tasks on the data control widget 107. For example, the data control widget 107 may include an option to select the UEs 101a-101n, wherein one or more of the UEs 101a-101n may be selected for communication. Further, the data control widget 107 may include a window showing a total capacity of data library 109 and/or a total capacity of the data storage medium 111, as well as an available space in the data library 109 and/or an available storage space in the data storage medium 111. The data control widget 107 may also allow the user to make a list of data that the user wants to transfer to another device. For example, a user may manually make a list of data to transfer to another device, depending on the available storage space of the device. A user may also choose to have the data control widget 107 automatically suggest a list of data to transfer to another device, and select data from the list of suggested data to transfer to another device. The data control widget 107 may also allow the user to manually add data to transfer, in addition to the selected data from the list of suggested data.

Further, the data control widget 107 may include interfaces that allow the user to communicate with any Internet-based websites. For example, the data control widget 107 may include visual interfaces that access the Internet to retrieve summary information about certain data files or media files (e.g., album art, metadata, etc.). The data control widget 107 may also include visual interfaces to display information from the data files on the list, such as popularity ratings, access history, album information of music data, size of the file, a time of creation of the file, etc. In addition, the data control widget 107 may also include interfaces to interact with a social network service (not shown) for sharing data.

The data storage medium 111 may store various types of information including information about the user of the UE 101. The information about the user may include user preferences, a user profile including the user's identification (ID), name, birthday, etc., as well as a user's tendency or history of accessing data.

By way of example, the UE 101 and the external device 103 communicate with each other and other components of the communication means 105 using well known, new or still developing protocols. In this context, a protocol includes a set of rules defining how the network nodes within the communication means 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

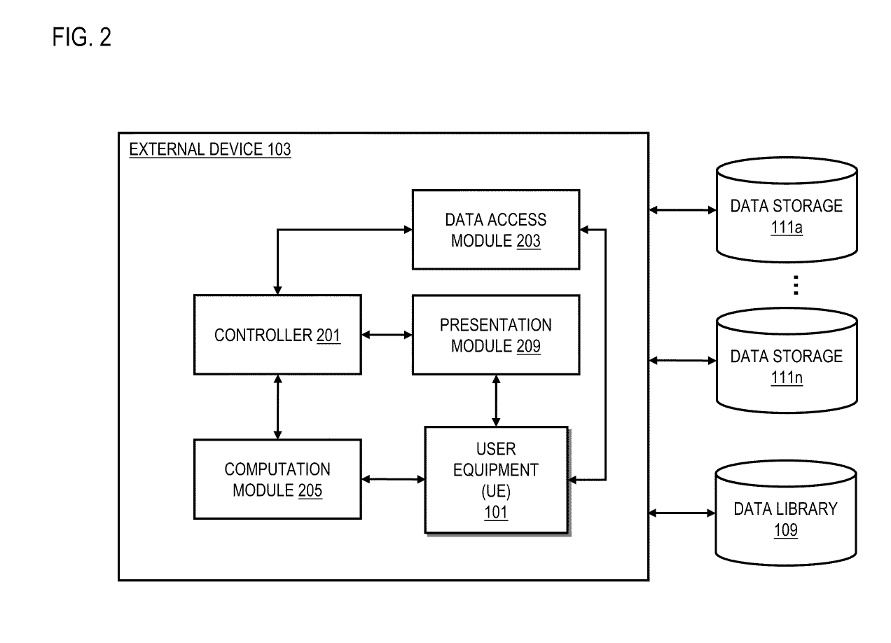

FIG. 2 is a diagram of the components of the external device 103, according to one embodiment. By way of example, the external device 103 includes one or more components for suggesting data for transfer. It is contemplated that the functions of these components may be combined in one or more components or performed by other components of equivalent functionality. In this embodiment, the external device 103 includes a controller 201, a data access module 203, a computation module 205 and a presentation module 207. The controller 201 oversees tasks, including tasks performed by the controller 201, the data access module 203, the computation module 205 and the presentation module 207. The data access module 203 manages the exchange of data between the UE 101 and the external device 103. The computation module 205 performs various computations and estimations based on given information, including selection of content to suggest for transfer between the external device 103 to the UE 101. The presentation module 207 manages information and provides options to choose a presentation of the information in the external device 103 and/or the UE 101, such that the information from the external device 103 and/or the UE 101 can be displayed on the data control widget 107. The external device 103 may also be connected to storage media such as the data library 109 such that the external device can access data in the data library 109 and transfer/copy the data in the data library 109 to another storage medium. The external device 103 may also be connected to the data storage medium 111 via the communication means 105 such that the external device 103 may be able to control the data in the data storage medium 111 and/or transfer the data from the data library 109 to the data storage medium 111.

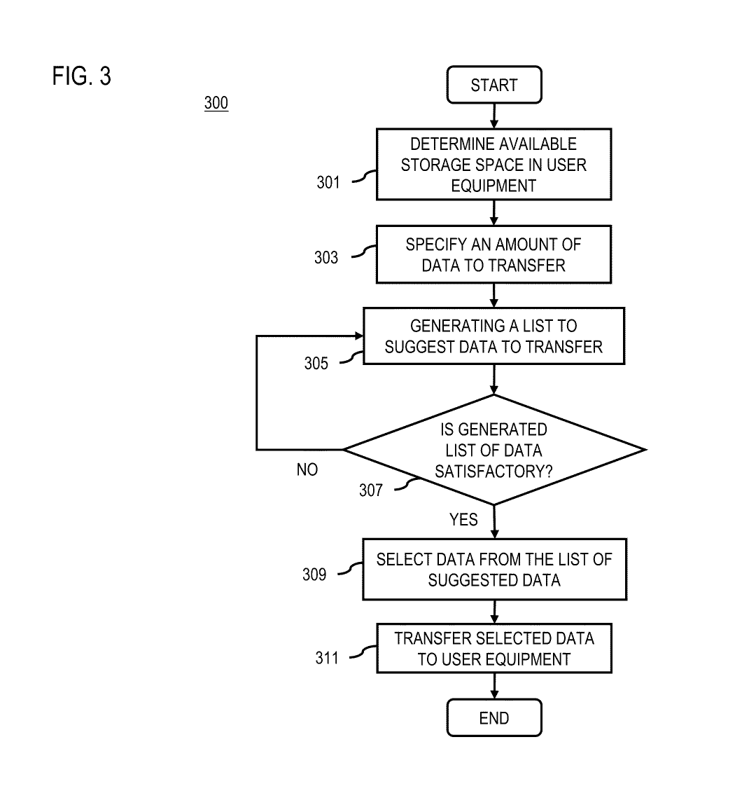

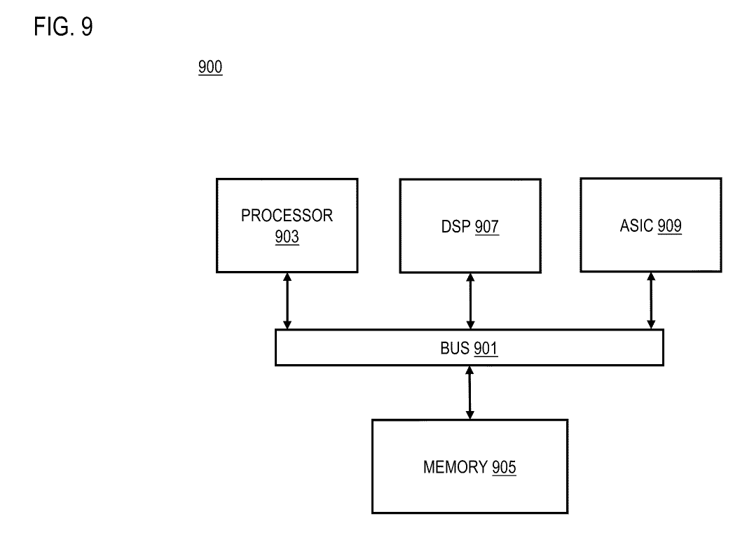

FIG. 3 is a flowchart of a process for suggesting data for transfer, according to one embodiment. In one embodiment, the data control widget 107 performs the process 300 and is implemented in, for instance, a chip set including a processor and a memory as shown FIG. 9. In step 301, an available storage space in the UE 101 (e.g., available storage space of the data storage medium 111) is determined. The available storage space in the UE 101 may be displayed on a screen to help a user understand how much data may be transferred to the data storage medium 111 of the UE 101. In step 303, an amount of data to transfer from the external device 103 to the UE 101 is specified. The amount of the data to transfer may be specified by a user. For example, a user may specify an amount of data to transfer by specifying a number representing either an amount or a portion of the storage medium capacity. As another example, a user may specify the amount of data to transfer by specifying the duration of playback of entire data to be transferred. Alternatively, the amount of the data to transfer may be automatically specified based on predetermined parameters.

One example of a parameter for specifying the amount of the data is the amount of available storage space in the data storage medium 111. In this case, the amount of the data to transfer can be automatically specified as the entire available storage space or a predetermined portion of the available storage space in the data storage medium 111. In step 305, a list is automatically generated to suggest data to transfer from the external device 103 to the UE 101. The list is automatically generated based on various parameters such as user preferences, historical patterns of media access (e.g., favorite musical tracks, most listened tracks, least listened tracks, etc.). In one embodiment, the list may be automatically generated based on the parameters when the amount of data to transfer is specified. In another embodiment, the data in the data library 109 may also be pre-selected based on the preferences, and be placed in a transfer pool of data, which may be constantly updated based on changes in the data of the data library 109 and/or the data of the data storage medium 111. In this embodiment, the list of data to suggest for transfer may be generated from the transfer pool of data by choosing the data in the transfer pool of data and then placing the data in the list of transfer suggestions. In step 307, the data control widget 107 determines whether the generated list of suggested data for transfer is satisfactory (e.g., whether the user accepts the suggested list of media to transfer). If the generated list is not satisfactory, then another list is automatically generated to suggest data for transfer. By way of example, the new list can suggest different media data or different combinations of media data to for transfer, based on different priorities and/or an order of the user preferences/profiles being executed. Further, the new list may replace the old list, and the old list may be removed from the user interface. If the generated list is satisfactory to the user, data is selected from the list of the suggested data, as shown in step 309. In this step, the data may be selected manually by a user, or may be automatically selected based on preferences or other parameters specified by the user, such as a size of data, a date of creation of data, a type of data, favorite musical tracks, most listened tracks, least listened tracks, etc. Then, in step 311, the selected data is transferred from the data library 109 of the external device 103 to the data storage medium 111 of the UE 101.

Further, when generating a list of data to suggest for transfer, the data control widget 107 may automatically check whether the suggested data is data that is set not to be transferred. For example, it can be configured that the data should not be transferred to the data storage medium 111 if the data in the data library 109 already exists in the data storage medium 111 and/or if the data listed in the transfer pool of data in the data library 109 already exists in the data storage medium 111. Such data then will not be suggested for transfer. Instead, the data control widget 107 can determine whether any of the metadata (e.g., album art, rating, track number, etc.) associated with such data is missing or has been changed and transfer only the metadata that is missing or changed. Further, the data in the data storage medium or the data listed in the transfer pool of data may be compared with a cache (not shown) of the data storage medium 111, to determine whether to suggest the data for transfer. The cache of the data storage medium 111 may keep a record of what data is present in the data storage medium 111 or what data has been stored and/or deleted in the data storage medium 111. The data control widget 107 may then choose to compare the data listed in the transfer pool of data with the record of data present in the data storage medium 111 or with the record of data that has been stored and/or deleted in the data storage medium 111, in order to determine whether to transfer the data. As another example, a user, content provider, network operator, and the like may flag certain data as nontransferable, and then the flagged data will not be suggested as data for transfer. In this example, a user may want to flag the data as nontransferable if the data is considered confidential and needs to stay within the data library 109. In another example, the content provider may also want to flag data that is licensed for play on a specific device and should not be transferred to another device.

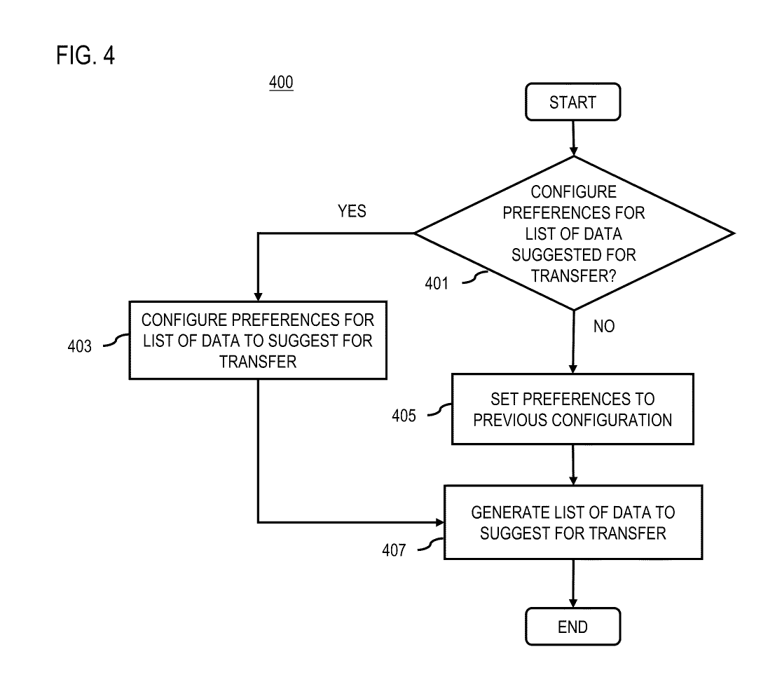

FIG. 4 is a flowchart of a process for suggesting data for transfer according to one embodiment. In one embodiment, the data control widget 107 performs the process 400 and is implemented in, for instance, a chip set including a processor and a memory as shown FIG. 9. In step 401, the data control widget 107 determines whether preferences considered for generating the list of the data to suggest are requested to be configured. If it is not requested that the preferences are configured, then the preferences are set to previous preferences, as shown in step 405, and the list of data to suggest for transfer is generated based on the preferences, as shown in step 407. As an example, the previous preferences may be preferences used in the transfer of data performed previously or may be a default setting for preferences, where the default setting may be configured by a user. If it is requested that the preference are configured, then the preferences are configured for the list of media suggested for transfer to the UE 101, as shown in step 403, and then the list of data to suggest for transfer is generated based on the preferences, as shown in step 407. The preferences may be configured in step 403 based on one or more of the various parameters. The parameters considered for configuring the preferences may include a frequency of access of data (e.g. a frequency of playback of media data), a frequency of play back of genre, a release date, popularity ratings, tempo or mood of the media, user profiles, etc. In order to configure the preferences, each of these parameters may be set to a certain setting, and a combination of some or all of these multiple parameters may be considered as the preferences that affect generation of the list of the suggested data for transfer. Alternatively, only a single parameter may be considered as the preferences.

Each of the parameters may be configured such that there is a sliding scale in varying degrees. In a case where a frequency of playback of media data is considered as a parameter, if the most frequently played media is heavily preferred, then the parameter may be weighted 100% towards the most frequently played media and 0% towards the least frequently played media. In this case, the most frequently played media will be suggested for transfer. In another example, the parameter may be set such that the parameter is weighted 60% towards most frequently played media and 40% towards least frequently played media. In this case, not all of the most frequently played media may be suggested for transfer, but only 60% of the most frequently played media are suggested and 40% of the least frequently played media will be suggested. Alternatively, this weighting may be applied differently in that the data around 60% of the most frequently played ranking may be suggested for transfer. In another example, the parameter may be set such that the parameter is weighted 50% towards most frequently played media and 50% towards the least frequently played media. In this case, this parameter may not apply any weight and thus the data is selected randomly based on this parameter. Alternatively, the weighting may be applied in that the data around 50% of the most frequently played ranking may be suggested for transfer.

Furthermore, each of the parameters may be given a priority score, such that each parameter may be weighted against other parameters differently. For example, if a frequency of access of data is considered more important than a frequency of playback of a genre in suggesting data for transfer, the priority score for the frequency of access of data may be set to be higher than the frequency of playback of the genre, such that more weight will be given to the frequency of access of data when suggesting data for transfer. As another example, in a case of music data, if a name of an artist for the music is considered more important and thus has a higher priority score than a genre of the music, then more weight will be given to the name of the artist than to the genre when suggesting data for transfer. It is further noted that if the genre of music is a more important parameter than the artist name, the data control widget 107 gives different priority scores to the parameters. These priority scores, in turn, can result in a different list of suggested data to transfer than if the artist name were a more important parameter the genre of music (as described in the previous example).

Examples of the parameters considered for configuring the preferences are discussed in more detail below. As discussed above, a history of accessing the data may be recorded, and be used as a parameter considered for configuring the preferences, in order to suggest files for transfer. In one example, the history may be based on the frequency of data access (e.g., the frequency each media file is played). Then, data for transfer may be suggested based on the history of data access. This parameter may be configured such that the most frequently accessed data are suggested for transfer because a user may consider these files to be important to the user. Alternatively, this parameter may be configured such that the least frequently accessed data are suggested for transfer because a user may consider these files to be the files that the user has not had enough access. For example, the user may consider the most played music files to be the music files that the user does not find interesting because the user has already listened to them enough. Further, each data may belong to one of various categories, and the data may be suggested for transfer based on the most frequent accessed category or the least frequent accessed category. In addition, depending on mood of the user, a mood of the media may be controlled as a parameter considered for configuring the preferences. For example, if a user may be in a cheerful mood and wants to hear fast music, the mood may be set to transfer fast-paced music. Further, the user's profile may contain information that can be used as a parameter used to configure the preferences for suggesting data. For example, if the user profile indicates that the user is travelling to a Latin American country, then the preference is set such that Latin American music such as salsa dance songs may be suggested for transfer. As another example, if the user profile shows that the user is on a vacation during Christmas holidays, holiday songs may be suggested for transfer. Further, these parameters may be automatically configured based on the user's preferences in transfer of the files, based on the history of transfer of the files.

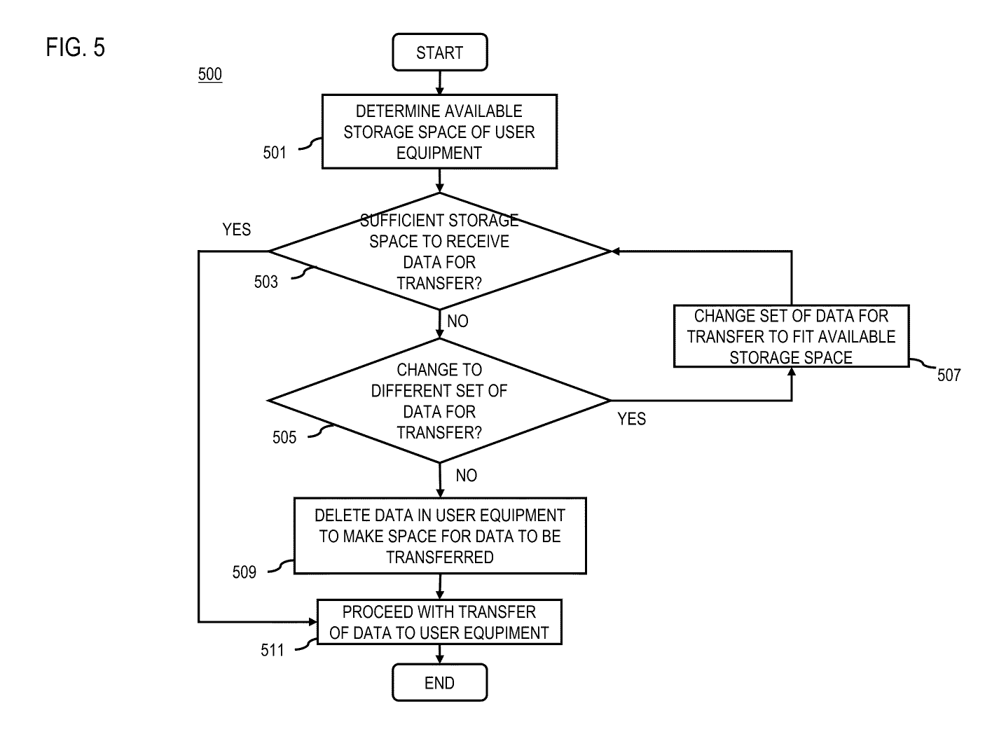

FIG. 5 is a flowchart of a process for suggesting data for transfer according to one embodiment. In one embodiment, the data control widget 107 performs the process 500 and is implemented in, for instance, a chip set including a processor and a memory as shown FIG. 9. In some cases, the amount of data to transfer may be smaller than or equal to or greater than the available storage space in the data storage medium 111. If the amount of data to transfer is greater than the available storage space in the data storage medium 111, some or all of the data in the data storage medium 111 can be deleted to make space for the data to be transferred. If the amount of data to transfer is smaller than or equal to the available storage space in the data storage medium 111, the control widget 107 need not delete any data in the data storage medium 111 to make space for the data to be transferred.

Thus, in step 501 of FIG. 5, an available storage space of the data storage medium 111 is determined. Next, the control widget 107 determines whether there is sufficient storage space in the data storage medium 111 to receive data for transfer from the data library 109 (step 503). In one embodiment, the specified amount of data for transfer is compared with the available storage space of the data storage medium 111 to determine if there is sufficient storage space in the data storage medium. In another embodiment, an amount of the selected data from the list of suggested data for transfer is compared with the available storage space of the data storage medium 111. If the control widget 107 determines that there is a sufficient storage space, then the control widget 107 initiates the transfer of data to the data storage medium 111, as shown in step 511. If the control widget 107 determines that there is not sufficient storage space, the control widget 107 then determines whether to generate and change to a different set of data for transfer (step 505). For example, the different set of data may be generated to fit in the available storage space in the data storage medium 111 (step 507). After generating the new set of data, the control widget 107 proceeds back to step 503. If changing to a different set of data is not requested, then some or all data in the data storage medium 111 is deleted to make sufficient space to accommodate the data to be transferred from the data library 109, as shown in step 509, and then the transfer of data proceeds as shown in step 511.

The deletion of data may be performed in a random fashion or based on user preferences. Further, the deletion of data from the data storage medium 111 may be preferable for some users if the users want to have a fresh set of data in the data storage medium 111. For example, data that have been in the data storage medium 111 for a long time can be deleted to make room for fresh content. In this way, the user may obtain a fresh set of songs or other media data to replace existing data.

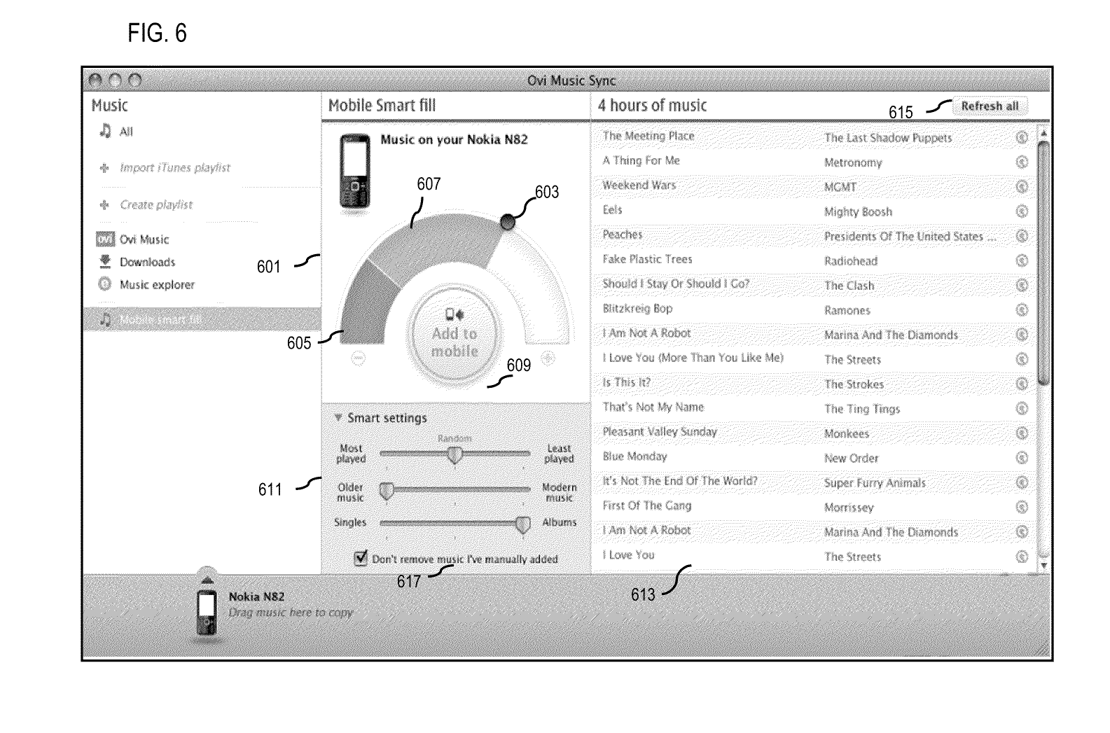

FIG. 6 is a diagram of a user interface utilized in the processes of FIG. 3, according to one embodiment. The user interface in this embodiment may be employed via the media control widget 107 of the external device 103. The user interface may also be employed in the UE 101. This particular example shows a user interface to selectively transfer music data to a portable device. The user interface has a mobile device section 601 showing a storage space of the data storage in a bar. In this example, a user is allowed to manually drag a knob/handle/actuator 603 on a user interface of the external device 103 to determine how much data to transfer to the mobile device. An occupied space of the storage in the mobile device is shown as one section of a bar in one shade 605 and a space to be occupied with the data to be transferred is shown as another section of the bar in a different shade 607. The shadeless portion (e.g. white portion) of the bar represents the available storage space of the mobile device. This user interface is also provided with a “Smart setting” 611 section that allows the user to set user preferences based on various parameters.

In this particular example, three parameters, such as Most played v. Least played, Older music v. Modern music, Singles v. Albums, are shown in this section 611. These parameters can be configured by the slide bars provided. Further, these parameters may be set as random, when the user does not have any preferences regarding such parameters. There may be more than three parameters that the user may configure. However, for display purposes, the user may choose three parameters to show on this section 611. For example, the user may want to display top three parameters that the user wants to customize the most. The other parameters may be hidden and may be configured in a different window, if the user desires to do so. The user interface may also provide a list of suggested files to transfer to the mobile device, as shown in 613. This list may be refreshed by choosing a refresh option 615 to obtain a new list of suggested files to transfer. Alternatively the list of the suggested files is updated/refreshed simultaneously to show suggested files to transfer when the handle 603 is moved to indicate a different amount of data to transfer. Further, a user may manually add media files to this list 613. If the list of the data files is acceptable to transfer to the mobile device, then the user may select the option 609 to add the data files to the mobile device. Alternatively, although not shown in this embodiment, a user may configure such that the user interface would automatically suggest enough data fill the entire free space of the mobile device. The user interface also has an option “Don't remove music I've manually added” 617. This option, when selected, does not allow removing of data that has been manually added to the list of the data to be transferred, even when a new set of data is suggested for transfer. The purpose of the options is that if the user manually adds data to the list to be transferred, it is important for the user to transfer these manually added files to the mobile device.

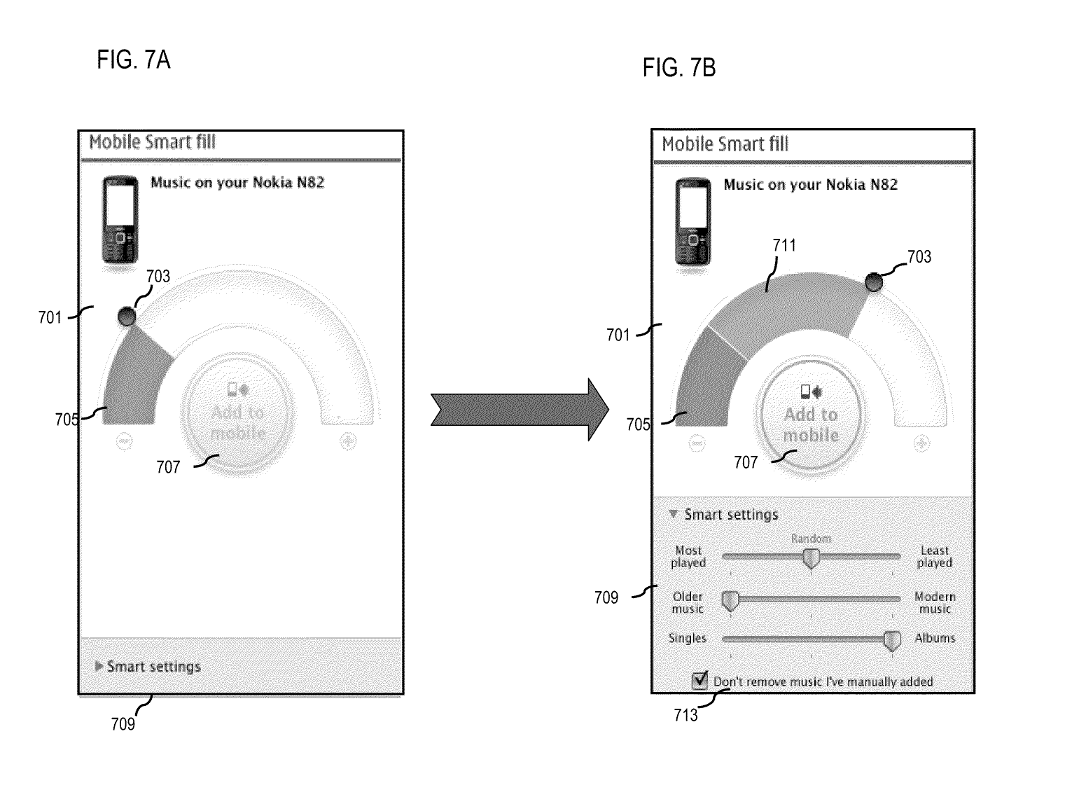

FIGS. 7A-7B are diagrams of user interfaces utilized in the processes of FIG. 3, according to one embodiment. FIG. 7A shows the user interface when the amount of data to transfer to the mobile device has not been specified. Similar to FIG. 6, FIG. 7A shows a mobile device section 701 showing a storage space of the data storage in a bar. An occupied space of the storage in the mobile device is shown as one section of a bar in one shade 705. A knob 703 is shown at the end of the bar 705 representing the occupied space. The knob 703 may be moved by a user to the right to specify an amount of data to transfer to the mobile device. In FIG. 7A, because the knob 703 has not been moved yet, there is no data to be transferred and thus the option to transfer data to the mobile device (“Add to mobile”) 707 is not available. FIG. 7A also shows a smart setting option 709 in a collapsed window, which does not show details of the smart settings. In FIG. 7B, when a user moves the knob 703 to specify an amount of data to transfer to the mobile device, a bar 711 in a different shade appears to represent the suggested data to be transferred, and the option “Add to mobile” 707 becomes available. FIG. 7B also shows the smart setting option 709 in an expanded window, showing three parameters (Most played v. Least played, Older music v. Modern music, Singles v. Albums). The user interface in FIG. 7B also has an option “Don't remove music I've manually added” 713, which has the same function as the option 617 in FIG. 6.

The processes described herein for suggesting data for transfer may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

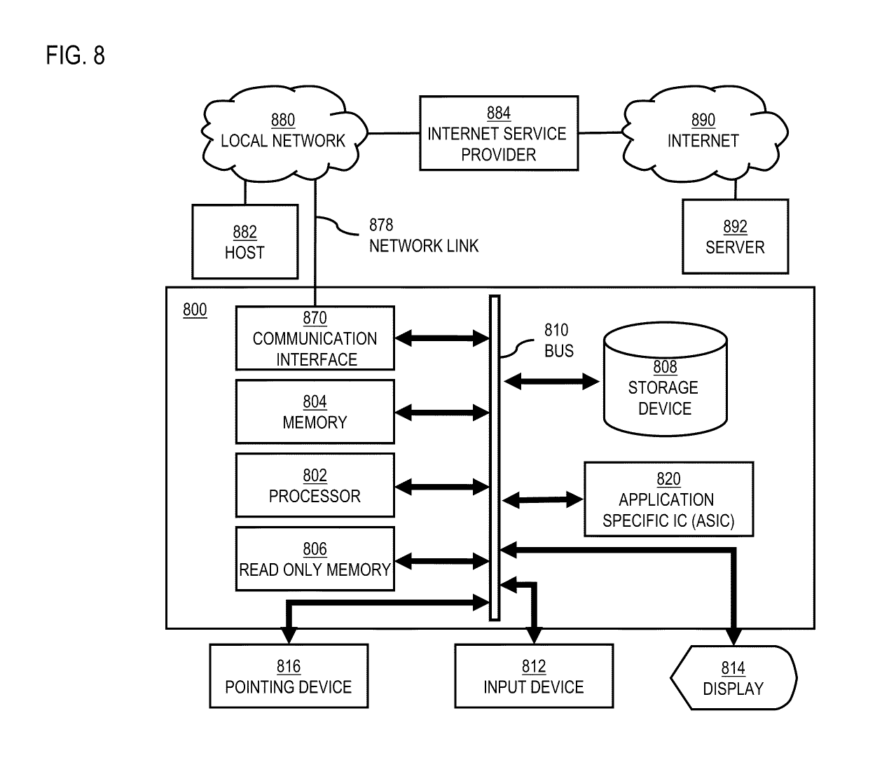

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to suggest data for transfer as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of suggesting data for transfer.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to suggesting data for transfer. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for suggesting data for transfer. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for suggesting data for transfer, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication means 105 for suggesting data for transfer to the UE 101.

The term “computer-readable medium” as used herein to refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to suggest data for transfer as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of suggesting data for transfer.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to suggesting data for transfer. The memory 905 also stores the data associated with or generated by the execution of the inventive steps.

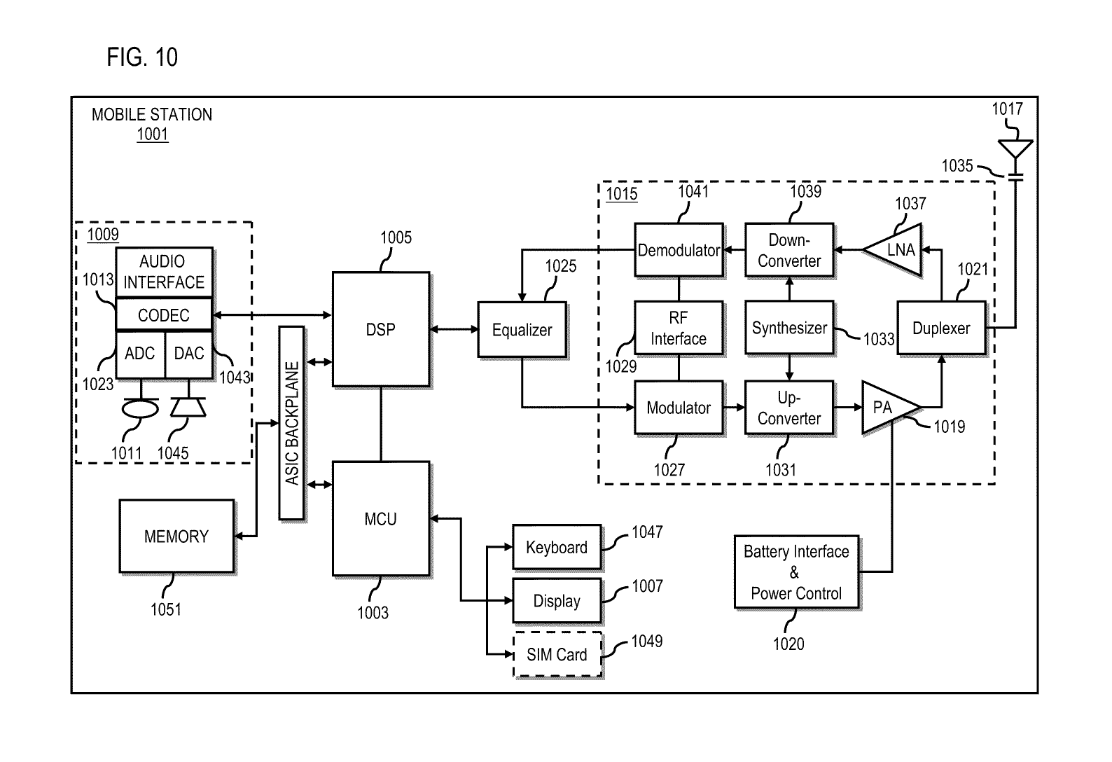

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of suggesting data for transfer. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of suggesting data for transfer. The display 10 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to suggest data for transfer. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving an input for specifying an amount of data to transfer from a first storage medium to a second storage medium;
determining an available storage space in the second storage medium;
generating, based on the input and the available storage space, a list of data to suggest for transfer from the first storage space to the second storage medium.

2. A method of claim 1, further comprising:
receiving another input for selecting data from the list;
causing, at least in part, transfer of the selected data from the first storage medium to the second storage medium.

3. A method of claim 1, wherein the input includes a number representing the amount of data or specifying a proportion of available storage space in the second storage medium or specifying an entire duration of playback of data.

4. A method of claim 1, wherein the specifying the amount of data comprises:
comparing a storage space occupied by the data in the list against the determined available storage space in the second storage medium; and
tagging data already stored in the second storage medium to be replaced by the data specified in the list based on the comparison.

5. A method of claim 1, wherein the generating the list includes randomly suggesting data from the first storage medium for the list, suggesting data from the first storage medium for the list based on user preferences, or a combination thereof.

6. A method of claim 1, wherein generating the list includes suggesting data from the first storage medium for the list based on one or more of a playback history of media files, genre, release date, mood, media rating and a user profile.

7. A method of claim 1, further comprising:
receiving another input for generating another list of suggested data; and
generating, based on the input, the another list of suggested data.

8. A method of claim 1, further comprising:
receiving another input for adding or deleting data to the list; and
modifying the list based on the another input.

9. A method of claim 1, wherein the input is received via a user interface actuator element.

10. An apparatus comprising:
at least one processor; and
at least one memory including computer program code, the at least one memory and the computer program code configured to, with the at least one processor, cause the apparatus to perform at least the following,
receive an input for specifying an amount of data to transfer from a first storage medium to a second storage medium;
determine an available storage space in the second storage medium;
generate, based on the input and the available storage space, a list of data to suggest for transfer from the first storage space to the second storage medium.

11. An apparatus of claim 10, wherein the apparatus is further caused, at least in part, to:
receive another input for selecting data from the list;
transfer the selected data from the first storage medium to the second storage medium.

12. An apparatus of claim 10, wherein the input includes a number representing the amount of data or specifying a proportion of available storage space in the second storage medium or specifying an entire duration of playback of data.

13. An apparatus of claim 10, wherein the specifying the amount of data comprises:
comparing a storage space occupied by the data in the list against the determined available storage space in the second storage medium; and
tagging data already stored in the second storage medium to be replaced by the data specified in the list based on the comparison.

14. An apparatus of claim 10, wherein, when the list is generated, data is suggested randomly from the first storage medium for the list, data is suggested from the first storage medium for the list based on user preferences, or a combination thereof.

15. An apparatus of claim 10, wherein generating the list includes suggesting data from the first storage medium for the list based on one or more of a playback history of media files, genre, release date, mood, media rating and a user profile.

16. An apparatus of claim 10, wherein the apparatus is further caused, at least in part, to:
receive another input for generating another list of suggested data; and
generate, based on the input, the another list of suggested data.

17. An apparatus of claim 10, wherein the apparatus is further caused, at least in part, to:
receive another input for adding or deleting data to the list; and
modify the list based on the another input.

18. An apparatus of claim 10, wherein the input is received via a user interface actuator element.

19. A computer-readable storage medium carrying one or more sequences of one or more instructions which, when executed by one or more processors, cause an apparatus to at least perform the following steps:
receiving an input for specifying an amount of data to transfer from a first storage medium to a second storage medium;
determining an available storage space in the second storage medium;
generating, based on the input and the available storage space, a list of data to suggest for transfer from the first storage space to the second storage medium.

20. A computer-readable storage medium of claim 19, wherein the apparatus is caused, at least in part, to further perform:
receiving another input for selecting data from the list;
causing, at least in part, transfer of the selected data from the first storage medium to the second storage medium.
